(19) United States
(12) Patent Application Publication
(10) Pub. No.: US 2022/0364879 A1
(43) Pub. Date: Nov. 17, 2022

(54) MEDIAN LINE METHOD IN MARITIME DELIMITATION BASED ON EARTH ELLIPSOID

(71) Applicant: National Marine Data and Information Service, Tianjin (CN)

(72) Inventors: Jianhui Zhang, Tianjin (CN); Xiaoting Fan, Tianjin (CN); Wenlu Bi, Tianjin (CN); Yanfen Gong, Tianjin (CN); Jinrong Li, Tianjin (CN)

(73) Assignee: National Marine Data and Information Service, Tianjin (CN)

(21) Appl. No.: 17/872,026

(22) Filed: Jul. 25, 2022

(30) Foreign Application Priority Data
Jul. 28, 2021 (CN) 202110854341.5

(51) Int. Cl. G01C 21/00; G06F 17/11

(52) U.S. Cl. CPC G01C 21/3807; G06F 17/11

(57) ABSTRACT

The present disclosure discloses a median line method in maritime delimitation based on an earth ellipsoid. The method is implemented by calculating a coordinate point of a median line of a maritime space, including: determining two delimitation base points A and B on a coastline of a certain country and a delimitation base point C on a coastline of the other country; calculating to obtain an equidistant point O with the same geodetic distance from the two points A and B; solving the geodetic distance from the point O to the point C according to the geodetic coordinates of the equidistant point O; determining whether the difference between respective geodetic distances of OC and OA is less than a first target error; if the difference is less than the first target error, then taking O as a point on a solved median line; and otherwise, adjusting the geodetic distance, and recalculating the coordinates of the point O.

### TECHNICAL FIELD

The present disclosure relates to the technical field of maritime delimitation, and in particular, to a median line method in maritime delimitation based on an earth ellipsoid, which gets rid of the influence of map projection.

### BACKGROUND ART

Maritime delimitation is a process of establishing sea boundaries between two or more coastal countries through negotiations between the countries involved or judgment or arbitration of a third party organization when the claimed scopes of sea rights overlap. Technically speaking, maritime delimitation is a problem about the division of a geometric space. A plurality of delimitation methods, such as a median line method, an angular bisector method, a vertical-shoreline method, a longitude parallel line method, and a latitude parallel line method, appear in the practice of international maritime delimitation. The most commonly used method in the international maritime delimitation practice is the median line method.

In 1987, the Canadian Carrera introduced a computer algorithm for generating a median line of maritime area delimitation, that is, a “three-point method”. The basic idea of the method is that: a combination of three base points (one for one party and two for the other) are found on the coastlines of both parties, and then a circle center is calculated as an equidistant line coordinate point by using “three points constructing circle”. The circle center cannot be directly solved on an earth ellipsoid, so the method first calculates coordinates of the circle center of three points on a projection plane, and then takes the coordinates as initial values to perform repeated iterative calculation on the earth ellipsoid until an error is within a reasonable range.

However, the iterative calculation of the “three-point method” of the ellipsoid proposed by Carrera is complex and has low operation efficiency. In addition, a circle center cannot be solved on the earth ellipsoid by directly using “three points in the same circle”, so the circle center needs to be calculated on a map plane first. Therefore, the method is very dependent on a specific map projection (different map projections need to be selected according to different latitude areas).

### SUMMARY

The present disclosure provides a median line method in maritime delimitation based on an earth ellipsoid.

The present disclosure provides the following solutions:

a median line method in maritime delimitation based on an earth ellipsoid includes:

determining respective geodetic coordinates of two delimitation base points A and B and a geodetic distance between the two points on a coastline of a certain country; determining geodetic coordinates of a delimitation base point C on a coastline of the other country;

calculating to obtain geodetic coordinates of an equidistant point O with the same geodetic distance from the two points A and B;

solving the geodetic distance from the point O to the point C in accordance with a formula of an inverse solution of a geodetic problem according to the geodetic coordinates of the equidistant point O;

determining whether the difference between respective geodetic distances of the OC and OA is less than a second target error;

if so, taking the point O as an equidistant point of the three delimitation base points A, B, and C; and

if not, recalculating the geodetic coordinates of the point O after adjusting the geodetic distance of OA.

Preferably, the geodetic distance of OA is adjusted through formula 4:

Δs=s+λ/2 4

In the formula, s is the geodetic distance of OA, and λ is the difference between respective geodetic distances of OC and OA.

Preferably, whether there are other delimitation base points in an area is scanned by taking the point O as a center and taking the geodetic distance of the two points A and B as a radius. If there are no other delimitation base points, then point O is a desired inflection point of a boundary; and if there are other delimitation base points, then the point O is not a desired boundary point, the geodetic coordinates of the three points A, B, and C are redetermined on a coast of both countries.

Preferably, the calculating to obtain geodetic coordinates of an equidistant point O with the same geodetic distance from the two points A and B includes that:

respective geodetic coordinates of the two points A and B and the geodetic distance between the two points on the earth ellipsoid are known;

the point O is set as an equidistant point with the same geodetic distance from the two points A and B, and the distance is known;

geodetic coordinates of an approximate point O′ equidistant from the two points A and B are calculated in accordance with a formula of a direct solution of a geodetic problem according to the geodetic coordinates of the point A, an approximate value of a geodetic azimuth of AO, and the geodetic distance of AO;

respective geodetic distances of O′A and O′B are calculated in accordance with a formula of an inverse solution of a geodetic problem according to the geodetic coordinates of three points A, B, and O′;

whether the difference between respective geodetic distances of the O′A and O′B is less than a second target error;

if so, the geodetic coordinates of the point O′ are taken as the geodetic coordinates of the point O; and

if not, the geodetic coordinates of the point O′ are recalculated after adjusting the approximate value of the geodetic azimuth of AO.

Preferably, the geodetic coordinates (B_{O′},L_{O′}) of the approximate point O′ and the reverse geodetic azimuth A_{O′A} of AO′ are calculated through formula 1:

$$\{ \begin{matrix}{B}_{{O}^{′}} = {f}_{B} ( {B}_{A} , {L}_{A} , {S}_{AO} , {A}_{AO} ) \\ {L}_{{O}^{′}} = {f}_{L} ( {B}_{A} , {L}_{A} , {S}_{AO} , {A}_{AO} ) \\ {A}_{{O}^{′} A} = {f}_{A} ( {B}_{PA} , {L}_{A} , {S}_{AO} , {A}_{AO} )\end{matrix} \qquad 1$$

In the formula, (B_{A}, L_{A}) are the geodetic coordinates of the point A, S_{AO} is the geodetic distance between the point A and the point O, and A_{AO} is an approximate value of the geodetic azimuth of AO.

Preferably, the approximate value A_{AO} of the geodetic azimuth of AO is calculated by the method as follows:

approximating a triangle ABO as a plane triangle;

setting φBAO=α, obtaining cosa=s/2r according to a trigonometric cosine theorem a²=b²+c²−2bc*cos A, and then obtaining α=arccos (s/2r). The approximate value of the geodetic azimuth of AO is A_{AO}, when A_{AB}−A_{AC}>0, A_{Ao}=A_{AB}−α; when A_{AB}−A_{AC}<0, A_{Ao}=A_{AB}+α; A_{AB} is a geodetic azimuth of a geodetic line AB; A_{AC} is an azimuth of a geodetic line AC; s is the geodetic distance of the two points A and B; and r is the geodetic distance from the point O to point A or point B.

Preferably, respective geodetic distances S_{O′A} and S_{O′Q} of the O′A and O′B are calculated through formula 2 and formula 3:

$$\{ \begin{matrix}{S}_{{O}^{′} A} = {f}_{s}^{′} ( {B}_{{O}^{′}} , {L}_{{O}^{′}} , {B}_{A} , {L}_{A} ) \\ {A}_{{O}^{′} A} = {f}_{A}^{′} ( {B}_{{O}^{′}} , {L}_{{O}^{′}} , {B}_{A} , {L}_{A} ) \\ {A}_{{AO}^{′}} = {f}_{A}^{′} ( {B}_{{O}^{′}} , {L}_{{O}^{′}} , {B}_{A} , {L}_{PA} )\end{matrix} \qquad 2$$

$$\{ \begin{matrix}{S}_{{O}^{′} B} = {f}_{s}^{′} ( {B}_{{O}^{′}} , {L}_{{O}^{′}} , {B}_{B} , {L}_{B} ) \\ {A}_{{O}^{′} B} = {f}_{A}^{′} ( {B}_{{O}^{′}} , {L}_{{O}^{′}} , {B}_{B} , {L}_{PB} ) \\ {A}_{{BO}^{′}} = {f}_{A}^{′} ( {B}_{{O}^{′}} , {L}_{{O}^{′}} , {B}_{B} , {L}_{B} )\end{matrix} \qquad 3$$

In the formula: A_{O′A} is a geodetic azimuth of O′A, A_{AO′} is a reverse geodetic azimuth of O′A, (B_{B},L_{B}) is geodetic coordinates of point B, A_{O′B} is a geodetic azimuth of O′B, and A_{BO′} is a reverse geodetic azimuth of O′B.

Preferably, the approximate value of the geodetic azimuth of AO is adjusted to obtain ΔA_{AO}, and the geodetic coordinates of the point O′ is recalculated by substituting ΔA_{AO} into formula 1.

Preferably, ΔA_{AO}=A_{AO}+180*δ/πr, δ is the difference between S_{O′A} and S_{O′B′} and r is the geodetic distance from point O to the point A or the point B.

According to a specific embodiment provided by the present disclosure, the present disclosure discloses the following technical effects.

By the present disclosure, The median line method in maritime delimitation based on an earth ellipsoid may be implemented. In an implementation mode, the method may include: determining respective geodetic coordinates of two delimitation base points A and B and a geodetic distance between the two points on a coastline of a certain country; determining geodetic coordinates of a delimitation base point C on a coastline of the other country; calculating to obtain geodetic coordinates of an equidistant point O with the same geodetic distance from the two points A and B; solving the geodetic distance from point O to point C in accordance with a formula of an inverse solution of a geodetic problem according to the geodetic coordinates of the equidistant point O; determining whether the difference between respective geodetic distances of the OC and OA is less than a first target error; if so, taking the point O as the equidistant point of the three delimitation base points A, B, and C; and if not, recalculating the geodetic coordinates of the point O after adjusting the geodetic distance of OA. The method is more concise through an iterative approximation calculation algorithm, and can calculate an equidistant point of the three points that meet the requirement of accuracy without complex high-power operation. Meanwhile, distance calculation is performed on the earth ellipsoid, which gets rid of the influence of map projection and does not need to consider the selection of various map projection methods.

Of course, implementing any of the products of the present disclosure does not necessarily need to achieve all of the abovementioned advantages at the same time.

### BRIEF DESCRIPTION OF THE DRAWINGS

To describe the technical solutions in the embodiments of the present disclosure or in the prior art more clearly, the following briefly describes the drawings required for describing the embodiments. Apparently, the drawings in the following description are merely some embodiments of the present disclosure, and those of ordinary skill in the art may still derive other drawings from these drawings without creative efforts.

FIG. 1 is a schematic diagram of a construction process of a median line method in maritime delimitation based on an earth ellipsoid provided by the embodiment of the present disclosure.

FIG. 2 is a schematic diagram of a calculation process of a method for solving an equidistant point of two points on an earth ellipsoid provided by the embodiment of the present disclosure.

FIG. 3 is a schematic diagram of a coordinate position of a median line of a maritime area obtained by two methods in the embodiment of the present disclosure.

### DETAILED DESCRIPTION OF THE EMBODIMENTS

Technical solutions in the embodiments of the present disclosure will be clearly and completely described below with reference to the drawings in the embodiments of the present disclosure. Apparently, the described embodiments are merely part rather than all of the embodiments of the present disclosure. On the basis of the embodiments of the present disclosure, all other embodiments obtained by those of ordinary skill in the art without creative effort fall within the scope of protection of the present disclosure.

First, the calculation of the distance and the azimuth on an earth ellipsoid is described:

The calculation of the distance and the azimuth performed on the earth ellipsoid needs to use an earth ellipsoid geodetic problem calculation method, including a direct solution of a geodetic problem and an inverse solution of a geodetic problem. Assuming that a point on the earth ellipsoid has a geodetic longitude L and a geodetic latitude B, a geodetic length between two points is S, and a positive geodetic azimuth and a reverse geodetic azimuth are A and A. Since there are many formulas that can realize the calculation of geodetic problems on the earth ellipsoid. The embodiment of the application only describes by taking Vincenty formula as an example. It can be understood that any other formula that can realize the calculation of a geodetic problem on the earth ellipsoid is also applicable to the method provided by the present application.

The direct solution of the geodetic problem is a process of calculating geodetic coordinates (B_{Q},L_{Q}) of the other point and the reverse geodetic azimuth A_{QP} according to the known geodetic coordinates (B_{P},L_{P}) of a certain point P on a geodetic line, the geodetic length S_{PQ} from the point P to the other point Q on the geodetic line, and a geodetic azimuth A_{pQ}. That is, an equation set is solved:

$$\{ \begin{matrix}{B}_{Q} = {f}_{B} ( {B}_{P} , {L}_{P} , {S}_{PQ} , {A}_{PQ} ) \\ {L}_{Q} = {f}_{L} ( {B}_{P} , {L}_{P} , {S}_{PQ} , {A}_{PQ} ) \\ {A}_{QP} = {f}_{A} ( {B}_{P} , {L}_{P} , {S}_{PQ} , {A}_{PQ} )\end{matrix}$$

The inverse solution of the geodetic problem is a process of calculating the geodetic length S_{PQ} between the two points and the positive geodetic azimuth A_{PQ} and the reverse geodetic azimuth A_{QP} according to the known geodetic coordinates (B_{P}, L_{P}) and (B_{Q}, L_{Q}) of two different points P and Q on the geodetic line. That is, an equation set is solved:

$$\{ \begin{matrix}{S}_{PQ} = {f}_{S}^{′} ( {B}_{P} , {L}_{P} , {B}_{Q} , {L}_{Q} ) \\ {A}_{PQ} = {f}_{A}^{′} ( {B}_{P} , {L}_{P} , {B}_{Q} , {L}_{Q} ) \\ {A}_{QP} = {f}_{{A}^{′}}^{′} ( {B}_{P} , {L}_{P} , {B}_{Q} , {L}_{Q} )\end{matrix}$$

### EMBODIMENT

The embodiment of the present disclosure provides a median line method in maritime delimitation based on an earth ellipsoid. The method may include that:

Respective geodetic coordinates of two delimitation base points A and B and a geodetic distance between the two points on a coastline of a certain country are determined. Geodetic coordinates of a delimitation base point C on a coastline of the other country is determined.

Geodetic coordinates of an equidistant point O with the same geodetic distance from the two points A and B are calculated by a method for solving an equidistant point of two points on the earth ellipsoid provided by Embodiment 1.

The geodetic distance from point O to point C is solved in accordance with a formula of an inverse solution of a geodetic problem according to the geodetic coordinates of the equidistant point O.

Whether the difference between respective geodetic distances of the OC and OA is less than a first target error is determined.

If so, the point O is taken as an equidistant point of the three delimitation base points A, B, and C.

If not, the geodetic coordinates of the point O is recalculated after adjusting the geodetic distance of OA.

In the abovementioned mode, the equidistant point of the three points is calculated by finding other combinations of delimitation base points on the coastlines of both countries, until all combinations are used, and finally, various points are connected in sequence to form a median line of a maritime space.

Specifically, the geodetic distance of OA is adjusted through formula 4:

Δs=s+λ/2 4

In the formula, s is the geodesic distance of OA, and λ is the difference between respective geodesic distances of OC and OA.

Further, whether there are other delimitation base points in an area is scanned by taking the point O as a center and taking the geodetic distance of the two points A and B as a radius. If there are no other delimitation base points, then point O is a desired inflection point of a boundary; and if there are other delimitation base points, then the point O is not a desired boundary point, and the geodetic coordinates of points A, B, and C are redetermined.

The embodiment of the application provides a new method for generating a median line of a maritime area based on an earth ellipsoid, that is, an equidistant point of three points is directly calculated on the earth ellipsoid, which completely gets rid of the influence of map projection. The core of the method is to convert a three-point equidistant problem of an earth ellipsoid into solving an equidistant point of two points first, then solving an equidistant point of a third point, and finally performing condition determination. The point that meets an error requirement is an equidistant point of the three points.

Respective geodetic coordinates of two points P and Q and the geodetic distance between the two points may be calculated by a plurality of methods in practice. For example, in an implementation mode, the embodiment of the present application may provide the calculation of geodetic coordinates of an equidistant point O with the same geodetic distance from the two points A and B, which includes that:

respective geodetic coordinates of the two points A and B and the geodetic distance between the two points on the earth ellipsoid are known;

the point O is set as an equidistant point with the same geodetic distance from the two points A and B, and the distance is known;

geodetic coordinates of an approximate point O′ equidistant from the two points A and B are calculated in accordance with a formula of a direct solution of a geodetic problem according to the geodetic coordinates of point A, an approximate value of a geodetic azimuth of AO, and the geodetic distance of AO.

Specifically, the geodetic coordinates (B_{O′}, L_{O′}) of the approximate point O′ and the reverse geodetic azimuth A_{O′A} of AO′ are calculated through formula 1:

$$\{ \begin{matrix}{B}_{{O}^{′}} = {f}_{B} ( {B}_{A} , {L}_{A} , {S}_{AO} , {A}_{AO} ) \\ {L}_{{O}^{′}} = {f}_{L} ( {B}_{A} , {L}_{A} , {S}_{AO} , {A}_{AO} ) \\ {A}_{{O}^{′} A} = {f}_{A} ( {B}_{PA} , {L}_{A} , {S}_{AO} , {A}_{AO} )\end{matrix} \qquad 1$$

In the formula, B_{A}, L_{A} are respectively the geodetic coordinates of point A, S_{AO} is the geodesic distance between the point A and the point O, and A_{AO} is an approximate value of the geodetic azimuth of AO.

The approximate value A_{AO} of the geodetic azimuth of AO is calculated by the method as follows.

A triangle ABO is as approximated as a plane triangle:

∠BAO=α is set, cos α=s/2r is obtained according to a trigonometric cosine theorem a²=b²+c²−2bc*cos A, and then α=arccos (s/2r) is obtained. The approximate value of the geodetic azimuth of AO is A_{AO}, when A_{AB}−A_{AC}>0, A_{Ao}=A_{AB}−α; and when A_{AB}−A_{AC}<0, A_{Ao}=A_{AB}+α. A_{AB} is a geodetic azimuth of a geodesic line AB; A_{AC} is an azimuth of a geodesic line AC; s is the geodesic distance of the two points A and B; and r is the geodesic distance from point O to point A or point B.

Respective geodetic distances S_{O′A} and S_{O′Q} of the O′A and O′B are calculated through formula 2 and formula 3:

$$\{ \begin{matrix}{S}_{{O}^{′} A} = {f}_{s}^{′} ( {B}_{{O}^{′}} , {L}_{{O}^{′}} , {B}_{A} , {L}_{A} ) \\ {A}_{{O}^{′} A} = {f}_{A}^{′} ( {B}_{{O}^{′}} , {L}_{{O}^{′}} , {B}_{A} , {L}_{A} ) \\ {A}_{{AO}^{′}} = {f}_{A}^{′} ( {B}_{{O}^{′}} , {L}_{{O}^{′}} , {B}_{A} , {L}_{PA} )\end{matrix} \qquad 2$$

$$\{ \begin{matrix}{S}_{{O}^{′} B} = {f}_{s}^{′} ( {B}_{{O}^{′}} , {L}_{{O}^{′}} , {B}_{B} , {L}_{B} ) \\ {A}_{{O}^{′} B} = {f}_{A}^{′} ( {B}_{{O}^{′}} , {L}_{{O}^{′}} , {B}_{B} , {L}_{PB} ) \\ {A}_{{BO}^{′}} = {f}_{A}^{′} ( {B}_{{O}^{′}} , {L}_{{O}^{′}} , {B}_{B} , {L}_{B} )\end{matrix} \qquad 3$$

In the formula: A_{O′A} is a geodetic azimuth of O′A, A_{AO} is a reverse geodetic azimuth of O′A, (B_{B},L_{B}) is geodetic coordinates of point B, A_{O′B} is a geodetic azimuth of O′B, and A_{BO′} is a reverse geodetic azimuth of O′B.

Respective geodetic distances of O′A and O′B are calculated in accordance with a formula of an inverse solution of a geodetic problem according to the geodetic coordinates of three points A, B, and O′.

Whether the difference between the geodetic distances of the O′A and O′B is less than a second target error is determined. The second target error may be determined according to the actually required calculation accuracy. For example, the distance between two selected two points is 200 nautical miles, and then the first target error may be set as 0.1 meter.

If so, the geodetic coordinates of the point O′ are taken as the geodetic coordinates of the point O.

If not, the geodetic coordinates of the point O′ are recalculated after adjusting the approximate value of the geodetic azimuth of AO.

The approximate value of the geodetic azimuth of AO is adjusted to obtain ΔA₄₀, and the geodetic coordinates of the point O′ is recalculated by substituting ΔA_{AO} into formula 1. ΔA_{AO}=A_{AO}+180*δ/π*r, S is the difference between S_{O′A} and S_{O′Q}, and r is the geodetic distance from the point O to the point A or the point B.

The median line method in maritime delimitation based on an earth ellipsoid of the present disclosure will be described in detail below through a specific example.

The method for solving a boundary point of a maritime area provided by the present application is described in detail below through a specific example.

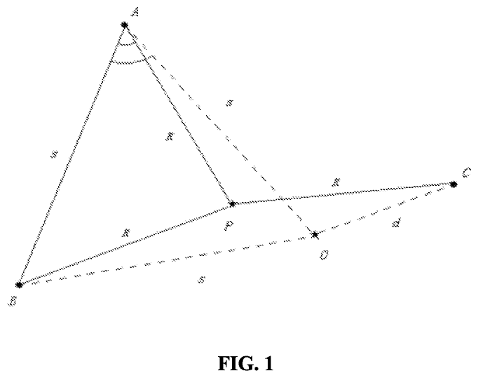

Referring to FIG. 1, two delimitation base points A((B_{A}, L_{A}) and B ((B_{B},L_{B}) on a coast of a certain country, and one delimitation base point C(B_{C}, L_{C}) on a coast of the other country are known, the geodesic distance of the two points A and B is s, and a point P with equal geodesic distance from point A, point B, and point C is solved.

A calculation process is as follows.

Step one: an equidistant point between point A and point B is solved. In order to facilitate calculation and understanding, an equilateral triangle □ABO is constructed with by taking two points A and B on the coast of a country as vertices and the length s of AB as the length of a side. According to a method provided by the embodiment to solve the equidistant point of two points on an earth ellipsoid, an equidistant point of points A and B are iteratively calculated until the point that meets a specified error is the solved point O.

Step two: the distance from a third point is solved. After the accurate position of point O is solved, the distance d from point O to point C of the other country is solved in accordance with a formula of an inverse solution of a geodetic problem, and λ=d−s is calculated. If 2 is less than the specified error, the point O is an equidistant point of the three points. On the contrary, s is adjusted, s=s+λ/2, and point O is recalculated by substituting s into step one, and iterative calculation is performed until point O that satisfies an error condition is solved.

Step three: condition determination. Assuming that the finally solved equidistant point of the three points is P, then whether there are other delimitation base points in an area is scanned by taking point P as a center and s as a radius. If there are no other delimitation base points, then point P is a desired inflection point of a boundary. On the contrary, point P is not a solved boundary point, and three points must be reselected to calculate according to the abovementioned steps.

Method for calculating an equidistant point of two points on an earth ellipsoid

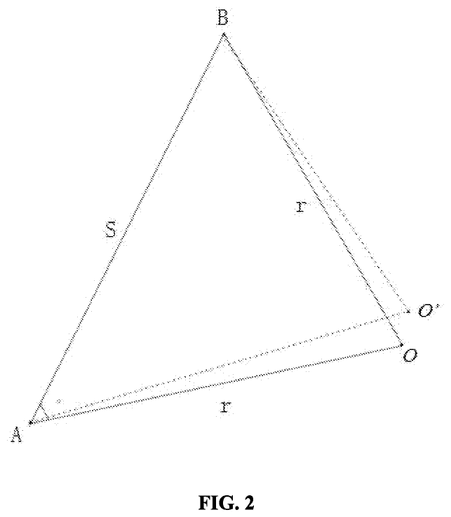

Referring to FIG. 2, assuming that two points A(B_{A}, L_{A}) and B((B_{B},L_{B}) are on the earth ellipsoid, the geodetic distance of the two points A and B is s, the geodesic azimuth from the point A to the point B is A_{AB}, and the point O is an equidistant point with the geodetic distance r from point A and point B, the geodetic coordinates of point O are solved. The triangle ABO is approximated as a plane triangle, and the geodetic coordinates of point O are calculated through iterative approximation. A calculation process is as follows:

(1) ∠BAO is calculated. ∠BAO=α is set, cos α=s/2r is obtained according to trigonometric cosine theorem a²=b²+c²−2bc*cos A, and then α=arccos (s/2r).

(2) An approximate point O′ with equal distance from the point A and the point B is calculated. The geodetic coordinates (B_{O′},L_{O′}) of the approximate point O′ of point O is calculated in accordance with a formula of a direct solution of a geodetic problem according to the geodetic coordinates (B_{A}, L_{A}) of the point A. The approximate value of the geodetic azimuth of AO is A_{AO}, when A_{AB}−A_{AC}>0, A_{AO}=A_{AB}−α; when A_{AB}−A_{AC}<0, A_{Ao}=A_{AB}+α; A_{AB} is a geodetic azimuth of a geodetic line AB; A_{AC} is an azimuth of a geodetic line AC; s is the geodetic distance of the two points A and B; and r is the geodetic distance from the point O to point A or point B.

(3) An actual point O with equal distance from point A and point B is calculated. The geodetic distance r1 and r2 of O′A and O′B are calculated in accordance with a formula of an inverse solution of a geodetic problem according to the geodetic coordinates of three points A(B_{A}, L_{A}), B((B_{B},L_{B}), and O′(B_{O′},L_{O′}), where δ=r₁−r₂. If δ is less than a specific error, the point O is an equidistant point from point A and point B. Otherwise, A_{AO}=A_{AO}+180*δ/π*r, then A_{AO} is substituted in step (2) and step (3) to recalculate the point O′ until δ meets a specified error, and the solved point O is an equidistant point from the point A and the point B.

The method for solving an equidistant point from two points on an earth ellipsoid provided by the present application is more concise through an iterative approximation calculation algorithm, and can calculate a result that meets the requirement of accuracy without complex high-power operation. Meanwhile, distance calculation is performed on the earth ellipsoid, which gets rid of the influence of map projection and does not need to consider the selection of various map projection methods.

The calculation accuracy of the method for solving a coordinate point of a median line of a maritime area based on an earth ellipsoid provided by the application is verified.

A maritime area with east-west opposite coasts of both parties is selected as a virtual delimitation maritime space. The west side of the maritime area is party A, and the east side of the maritime area is party B. A median line of an overlapped maritime area of both parties is reckoned by taking this as an example. Nine delimitation base points are selected along the coast of party A, and eleven delimitation base points are selected along the coast of party B (see Table 1). The coordinate unit is decimal degree, the calculation result retains 6 decimal places, “-” means that the point is located in south latitude or west longitude, and the distance calculation error is 10⁻⁴ m.

TABLE 1
WGS-84 coordinate system of starting coordinates of delimitation
between both parties

| | Coordinates of party A | | Coordinates of party B | |
|---|---|---|---|---|
| Number | Longitude (°) | Latitude (°) | Longitude (°) | Latitude (°) |
| 1 | 119.018231 | 0.945006 | 120.081850 | 0.752270 |
| 2 | 118.804079 | 0.795100 | 120.003328 | 0.688024 |
| 3 | 118.025996 | 0.766546 | 119.782038 | 0.202614 |
| 4 | 117.647661 | −0.432702 | 119.617855 | 0.002739 |
| 5 | 117.633385 | −0.803898 | 119.289489 | −1.325000 |
| 6 | 116.612596 | −2.210159 | 118.789803 | −2.645601 |
| 7 | 116.41986 | −3.423684 | 118.761249 | −2.845475 |
| 8 | 116.298507 | −3.966201 | 118.832633 | −3.445100 |
| 9 | 116.06294 | −4.087554 | 118.932570 | −3.637836 |
| 10 | — | — | 119.068200 | −3.873403 |
| 11 | — | — | 118.989677 | −4.201768 |

The delimitation base points of both parties are taking as starting data, and coordinates of a median line of a maritime area generated by the method and the Geocap MLB 2.3.4 for ArcGIS10.2, which was developed by Geocap Company in Norway are compared (see Table 2).

TABLE 2
Delimitation result comparison

| | “Three-point method” of | | Method provided by | |
|---|---|---|---|---|
| | Geocap software | | the present application | |
| Number | Longitude (°) | Latitude (°) | Longitude (°) | Latitude (°) |
| 1 | 119.545193 | 0.950153 | 119.620540 | 1.242777 |
| 2 | 119.465975 | 0.642444 | 119.465975 | 0.642444 |
| 3 | 119.281997 | 0.450620 | 119.281997 | 0.450620 |
| 4 | 119.225873 | 0.414424 | 119.225873 | 0.414424 |
| 5 | 118.630625 | −0.205166 | 118.630625 | −0.205166 |
| 6 | 118.688214 | −0.469236 | 118.688214 | −0.469236 |
| 7 | 118.588502 | −0.655162 | 118.588502 | −0.655162 |
| 8 | 118.267305 | −1.689246 | 118.267305 | −1.689246 |
| 9 | 117.786731 | −1.994681 | 117.786731 | −1.994681 |
| 10 | 117.669983 | −2.585315 | 117.669983 | −2.585315 |
| 11 | 117.553674 | −2.983007 | 117.553674 | −2.983007 |
| 12 | 117.627550 | −3.285265 | 117.627550 | −3.285265 |
| 13 | 117.621451 | −3.978886 | 117.621451 | −3.978886 |
| 14 | 117.643663 | −4.087804 | 117.643663 | −4.087804 |
| 15 | 117.633767 | −4.201768 | 117.435776 | −6.473682 |

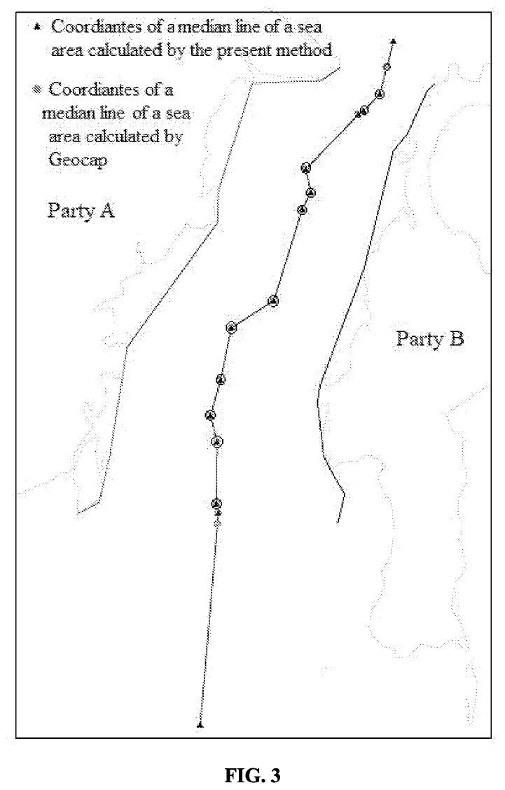

It can be seen from the analysis that the coordinates of an inflection point of a median line of a maritime area calculated by the method and the Geocap software are completely consistent except for the coordinates of a starting point and an ending point of the median line of the maritime area (see FIG. 3). “Note: FIG. 3 is a schematic diagram, is a virtual delimitation scenario, is only intended to show the median line delimitation method provided by Embodiment 2 of the present application, and does not prejudice to any claims of the parties in the maritime space.” There is a difference between coordinates of the starting point and the ending point of the median line in the two methods due to the adoption of different delimitation methods: the present method calculates by a boundary extension method, while Geocap directly takes a midpoint of the starting base points of both parties as the coordinates of the starting point of the median line, and takes the midpoint of the ending base points as the coordinates of the ending point of the median line.

It is also to be noted that relational terms such as first and second are only used to distinguish one entity or operation from another entity or operation herein, and do not necessarily require or imply the existence of any such actual relationship or order between these entities or operations. Moreover, the terms “include”, “contain” or any other variations thereof are intended to cover a non-exclusive inclusion, such that a process, method, article or device including a series of elements not only includes those elements, but also includes those elements that are not explicitly listed, or includes elements inherent to such a process, method, article or device. In the absence of more restrictions, elements defined by the phrase “include a/an . . . ” do not exclude the existence of additional identical elements in the process, method, commodity, or device that includes the elements.

The above is only a preferred embodiment of the present disclosure and is not intended to limit the scope of the present disclosure. Any modifications, equivalent replacements, improvements and the like made within the spirit and principle of the present disclosure shall fall within the scope of protection of the present disclosure.

What is claimed is:

1. A median line method in maritime delimitation based on an earth ellipsoid, comprising:
determining respective geodetic coordinates of two delimitation base points A and B and a geodetic distance between the two points on a coastline of a certain country; and determining geodetic coordinates of a delimitation base point C on a coastline of the other country;
calculating to obtain geodetic coordinates of an equidistant point O with the same geodetic distance from the two points A and B;
solving the geodetic distance from the point O to the point C in accordance with a formula of an inverse solution of a geodetic problem according to the geodetic coordinates of the equidistant point O;
determining whether the difference between respective geodetic distances of OC and OA is less than a first target error;
if so, taking the point O as an equidistant point of the three delimitation base points A, B, and C; and
if not, recalculating the geodetic coordinates of the point O after adjusting the geodetic distance of OA.

2. The median line method in maritime delimitation based on an earth ellipsoid according to claim 1, wherein the geodetic distance of OA is adjusted through formula 4:
Δs=s+λ/2 4
in the formula: s is the geodetic distance of OA, and λ is the difference between respective geodetic distances of OC and OA.

3. The median line method in maritime delimitation based on an earth ellipsoid according to claim 1, comprising: scanning whether there are other delimitation base points in an area by taking the point O as a center and taking the geodetic distance of the two points A and B as a radius, wherein if there are no other delimitation base point, then point O is taken as a solved inflection point of a boundary; and if there are other delimitation base points, then the point O is not a desired boundary point, the geodetic coordinates of points A, B, and C are redetermined.

4. The median line method in maritime delimitation based on an earth ellipsoid according to claim 1, wherein the calculating to obtain geodetic coordinates of an equidistant point O with the same geodetic distance from the two points A and B comprises that:
respective geodetic coordinates of the two points A and B and the geodetic distance between the two points on the earth ellipsoid are known;
point O is set as an equidistant point with the same geodetic distance from the two points A and B, and the distance is known;
geodetic coordinates of three points A, B, and point O′ equidistant from the two points A and B are calculated in accordance with a formula of a direct solution of a geodetic problem according to the geodetic coordinates of the point A, an approximate value of a geodetic azimuth of AO, and the geodetic distance of AO;
respective geodetic distance of O′A and O′B are calculated in accordance with a formula of an inverse solution of a geodetic problem according to the geodetic coordinates of three points A, B, and C;
whether the difference between the respective geodetic distances of the O′A and O′B is less than a second target error is determined;
if so, the geodetic coordinates of the point are taken as the geodetic coordinates of the point O; and
if not, the geodetic coordinates of the point O′ are recalculated after adjusting an approximate value of the geodetic azimuth of AO.

5. The median line method in maritime delimitation based on an earth ellipsoid according to claim 4, wherein the geodetic coordinates (B_{O′}, L_{O′}) of the approximate point and the reverse geodetic azimuth of A_{O′A} of O′A are calculated through formula 1:
$$\{ \begin{matrix}{B}_{{O}^{′}} = {f}_{B} ( {B}_{A} , {L}_{A} , {S}_{AO} , {A}_{AO} ) \\ {L}_{{O}^{′}} = {f}_{L} ( {B}_{A} , {L}_{A} , {S}_{AO} , {A}_{AO} ) \\ {A}_{{O}^{′} A} = {f}_{A} ( {B}_{PA} , {L}_{A} , {S}_{AO} , {A}_{AO} )\end{matrix} \qquad 1$$
in the formula, B_{A} and L_{A} are respectively the geodetic coordinates of point A, S_{AO} is the geodetic distance between the point A and the point O, and A_{AO} is an approximate value of the geodetic azimuth of AO.

6. The median line method in maritime delimitation based on an earth ellipsoid according to claim 5, wherein the approximate value A_{O′A} of the geodetic azimuth of AO is calculated by the method as follows:
approximating a triangle ABO as a plane triangle;
setting ∠BAO=α, obtaining cos α=s/2 according to a trigonometric cosine theorem a² b² c²−2bc*cos A, and then obtaining α=arccos (s/2r), wherein the approximate value of the geodetic azimuth of AO is A_{AO}, when A_{AB}−A_{AC}>0 then A_{Ao}=A_{AB}−α; when A_{AB}−A_{AC}<0, A_{Ao}=A_{AB}+α; A_{AB} is a geodetic azimuth of a geodetic line AB; A_{AC} is an azimuth of a geodetic line AC; s is the geodetic distance between the two points A and B; and r is the geodetic distance from point O to point A or point B.

7. The median line method in maritime delimitation based on an earth ellipsoid according to claim 5, wherein respective geodetic distances S_{O′A} and S_{O′Q} of O′A and O′B are calculated through formula 2 and formula 3:
$$\{ \begin{matrix}{S}_{{O}^{′} A} = {f}_{s}^{′} ( {B}_{{O}^{′}} , {L}_{{O}^{′}} , {B}_{A} , {L}_{A} ) \\ {A}_{{O}^{′} A} = {f}_{A}^{′} ( {B}_{{O}^{′}} , {L}_{{O}^{′}} , {B}_{A} , {L}_{A} ) \\ {A}_{{AO}^{′}} = {f}_{A}^{′} ( {B}_{{O}^{′}} , {L}_{{O}^{′}} , {B}_{A} , {L}_{PA} )\end{matrix} \qquad 2$$
$$\{ \begin{matrix}{S}_{{O}^{′} B} = {f}_{s}^{′} ( {B}_{{O}^{′}} , {L}_{{O}^{′}} , {B}_{B} , {L}_{B} ) \\ {A}_{{O}^{′} B} = {f}_{A}^{′} ( {B}_{{O}^{′}} , {L}_{{O}^{′}} , {B}_{B} , {L}_{PB} ) \\ {A}_{{BO}^{′}} = {f}_{A}^{′} ( {B}_{{O}^{′}} , {L}_{{O}^{′}} , {B}_{B} , {L}_{B} )\end{matrix} \qquad 3$$
in the formula: A_{O′A} is a geodetic azimuth of O′A, A_{AO′} is a reverse geodetic azimuth of O′A (B_{B},L_{B}) is geodetic coordinates of the point B, A_{O′B} is a geodetic azimuth of O′B, and A_{BO′} is a reverse geodetic azimuth of O′B.

8. The median line method in maritime delimitation based on an earth ellipsoid according to claim 7, wherein the approximate value of the geodetic azimuth of AO is adjusted to obtain ΔA_{AO}, and the geodetic coordinates of the point O′ is recalculated by substituting ΔA_{AO} into formula 1.

9. The median line method in maritime delimitation based on an earth ellipsoid according to claim 8, wherein ΔA_{AO}=A_{AO}+180*δ/π*r, δ is the difference between S_{O′A} and S_{O′Q}, and r is the geodetic distance from the point O to the point A or the point B.
